(19) United States
(12) Patent Application Publication
(10) Pub. No.: US 2025/0150714 A1
(43) Pub. Date: May 8, 2025

(54) DEVICE CONTROL METHOD, APPARATUS AND ELECTRONIC DEVICE

(71) Applicant: Beijing Youzhuju Network Technology Co., Ltd., Beijing (CN)

(72) Inventor: Andong SU, Beijing (CN)

(21) Appl. No.: 18/835,933

(22) PCT Filed: Feb. 16, 2023
(86) PCT No.: PCT/CN2023/076393

§ 371 Date: Aug. 5, 2024

(30) Foreign Application Priority Data
Feb. 24, 2022 (CN) 202210173987.1

(51) Int. Cl. H04N 23/698; H04N 23/695

(52) U.S. Cl. CPC H04N 23/698; H04N 23/695

(57) ABSTRACT

Embodiments of the disclosure disclose a device control method, apparatus, and electronic device. A particular implementation of the method includes: sending a shooting start instruction to a shooting terminal, so that the shooting terminal shoots a plurality of house images at a first position in a house room; in response to receiving the plurality of house images sent by the shooting terminal, generating a target panorama according to the plurality of house images, and displaying the target panorama, so that a user confirms that the house images are shot at a next position, or the house images are shot at a first position again; in response to the user confirming to shoot a house image at the next position, determining a second position in the house; and sending the second position information to the shooting terminal, so that the shooting terminal shoots a plurality of house images at the second position. In this implementation, a plurality of positions of a shooting terminal in a house can be controlled by means of a mobile terminal, and a plurality of house images are shot respectively. Thereby, the convenience of shooting a house image can be improved.

### CROSS REFERENCE TO RELATED APPLICATIONS

This application claims priority to Chinese Patent Application No. 202210173987.1, filed with the Chinese Patent Office on Feb. 24, 2022 and entitled ‘DEVICE CONTROL METHOD, APPARATUS AND ELECTRONIC DEVICE’, which is incorporated herein by reference in its entirety.

### FIELD

Embodiments of the present disclosure relate to the field of computer technologies, and in particular to device control method, apparatus and electronic device.

### BACKGROUND

In daily life, most people have a demand for sale or leasing houses. Therefore, some platforms for providing sale or leasing of houses have been derived. On these platforms, user can browse house information.

In some scenarios, a house image may be shot first, and then the house image is placed on the platform for the user to view.

### SUMMARY

The present disclosure content section is provided to introduce concepts in a simplified form, which are described in detail in the detailed description section that follows. The present disclosure content section is not intended to identify key features or essential features of claimed subject matter, nor is it intended to be used to limit scope of the claimed subject matter.

Embodiments of the present disclosure provide device control method and apparatus, and electronic device, by means of a mobile terminal, a shooting terminal may be controlled to shoot a plurality of house images respectively at a plurality of positions in a house room.

According to a first aspect, embodiments of the present disclosure provide a device control method. The method includes: sending a shooting start instruction to a shooting terminal, so that the shooting terminal shoots a plurality of house images at a first position in a house room; in response to receiving the plurality of house images sent by the shooting terminal, generating a target panorama based on the plurality of house images, and displaying the target panorama, so that a user confirms to shoot a house image at a next position, or to re-shoot a house images at the first position; if the user confirms to shoot the house image at the next position, determining a second position in the house room; and sending second position information to the shooting terminal, so that the shooting terminal shoots a plurality of house images at the second position.

According to a second aspect, embodiments of the present disclosure provide a device control apparatus. The apparatus includes: a first sending unit for sending a shooting start instruction to a shooting terminal, so that the shooting terminal shoots a plurality of house images at a first position in a house room; a display unit for in response to receiving the plurality of house images sent by the shooting terminal, generating a target panorama based on the plurality of house images, and displaying the target panorama, so that a user confirms to shoot a house image at a next position, or to re-shoot a house image at a first position again; a determination unit for, if the user confirms to shoot the house image at the next position, determining a second position in the house room; a second sending unit for, sending second position information to the shooting terminal, so that the shooting terminal shoots a plurality of house images at the second position.

According to a third aspect, embodiments of the present disclosure provides an electronic device, including: one or more processors; a storage apparatus for storing one or more programs, when the one or more programs are executed by the one or more processors, causing the one or more processors to implement the device control method according to the first aspect.

According to a fourth aspect, embodiments of the present disclosure provides a computer readable medium, on which a computer program is stored, wherein the computer program when being executed by a processor, implements steps of the device control method according to the first aspect.

Embodiments of the present disclosure provide a device control method and apparatus, and electronic device, by means of a mobile terminal, a shooting terminal may be controlled to shoot a plurality of house images respectively at a plurality of positions in a house room. Thereby, convenience of shooting a house image can be improved.

In addition, for each position, a target panorama can be generated according to a house image shot at the position, and the target panorama is displayed, so that a user can confirm to shoot a house image at a next position by viewing the target panorama, or to re-shoot a house image at the position. Thereby, quality of shot house image can be improved.

### BRIEF DESCRIPTION OF THE DRAWINGS

The above and other features, advantages and aspects of each embodiment of the present disclosure will become more apparent with reference to following detailed description taken in conjunction with drawings. The same or like reference numerals represent the same or like elements throughout the drawings. it should be understood that the drawings are illustrative, components and elements are not necessarily drawn to scale.

FIG. 1 is a flowchart of one embodiment of a device control method of the present disclosure;

FIG. 2 is a flowchart of one embodiment of determining a second position in a device control method of the present disclosure;

FIG. 3 is a schematic diagram of one embodiment of determining a target point in a device control method of the present disclosure;

FIG. 4 is a schematic structural diagram of one embodiment of a device control apparatus of the present disclosure;

FIG. 5 is an exemplary system architecture to which a device control method of the present disclosure may be applied in one embodiment;

FIG. 6 is a schematic diagram of a basic structure of an electronic device provided by embodiments of the present disclosure.

### DETAILED DESCRIPTION

Embodiments of the present disclosure will be described in more detail below with reference to drawings. Although certain embodiments of the present disclosure are shown in the drawings, it should be understood that the present disclosure may be implemented in various forms and should not be construed as being limited to the embodiments set forth herein, but rather these embodiments are provided for a thorough and complete understanding of the present disclosure. It should be understood that the drawings and embodiments of the present disclosure are only for illustrative purposes and are not intended to limit scope of the present disclosure.

It should be understood that, each step recorded in method embodiments of the present disclosure may be executed in different orders, and/or executed in parallel. In addition, the method embodiments may include additional steps and/or omit the steps illustrated performing. The scope of the present disclosure is not limited in this respect.

The term ‘including’ and variations thereof, as used herein, is inclusive, i.e., ‘including but not limited to’ The term ‘based on’ is ‘based at least in part on’. The term “one embodiment” means ‘at least one embodiment’; the term ‘another embodiment’ means ‘at least one further embodiment’; the term ‘some embodiments’ means ‘at least some embodiments’. Relevant definitions of other terms will be given in following description.

It should be noted that, the ‘first’, ‘second’, and other concepts mentioned in the present disclosure are only used to distinguish different apparatuses, modules, or units, but are not used to limit sequence or dependency of functions performed by these apparatuses, modules, or units.

It should be noted that the modifications of ‘a’ and ‘a plurality’ mentioned in the present disclosure are illustrative rather than restrictive, and a person skilled in the art should understand that they should be understood as ‘one or more’ unless context clearly indicates otherwise.

The names of messages or information interacted between a plurality of devices in the embodiments of the present disclosure are only for illustrative purposes, and are not intended to limit the scope of these messages or information.

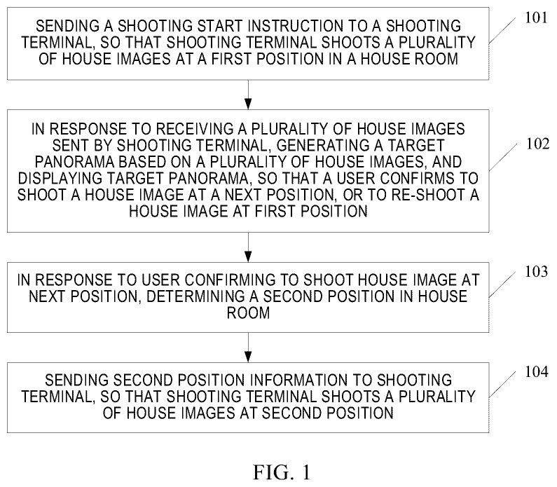

Please refer to FIG. 1, which illustrates a procedure of one embodiment of a device control method of the present disclosure. As shown in FIG. 1, the device control method includes following steps:

Step 101, sending a shooting start instruction to a shooting terminal, so that the shooting terminal shoots a plurality of house images at a first position in a house room.

In practice, a mobile terminal may control the shooting terminal to shoot a plurality of house images at a plurality of positions in a house. For each position, the shooting terminal may transmit a plurality of house images shot at the position to the mobile terminal.

Step 102, in response to receiving the plurality of house images sent by the shooting terminal, generating a target panorama based on the plurality of house images, and displaying the target panorama, so that a user confirms to shoot a house image at a next position, or to re-shoot a house image at the first position.

The target panorama is generated from a plurality of house images shot at one position. Therefore, the target panorama may only present a partial view in the house room.

The user may check whether generated target panorama meet expectations. If the target panorama meet the expectations, the user may confirm to shoot a house image at a next position. If the target panorama does not meet expectations, the user may confirm to re-shoot a house image at the first position.

Step 103, if the user confirms to shoot the house image at the next position, determining a second position in the house room.

Step 104, sending second position information to the shooting terminal, so that the shooting terminal shoots a plurality of house images at the second position.

In some scenarios, the user may move the shooting terminal, and after moving to the second position, the shooting terminal may shoot a plurality of house images in the second position.

It is not difficult to understand that the shooting terminal may send a plurality of house images shot at the second position to the mobile terminal. The mobile terminal may generate a target panorama according to the plurality of house images, and display the target panorama. The user can check whether the target panorama meet expectations, so as to confirm to shoot a house image at the next position, or to re-shoot a house image at the second position.

In this embodiment, by means of a mobile terminal, a shooting terminal may be controlled to shoot a plurality of house images respectively at a plurality of positions in a house room. Thereby, convenience of shooting a house image can be improved.

In addition, for each position, a target panorama can be generated according to a house image shot at the position, and the target panorama is displayed, so that the user can confirm to shoot a house image at a next position by viewing the target panorama, or to re-shoot a house image at the position. Thereby, quality of the shot house image can be improved.

In some embodiments, the shooting terminal is provided with a rotatable pan-tilt. In practice, rotation of the pan-tilt may drive rotation of the shooting terminal.

The shooting terminal may shoot a plurality of house images at the same position in the house room by executing a shooting step for a target times, wherein the shooting step includes steps S1-S2.

Step S1, shooting at least one house image.

Step S2, after shooting is completed, rotating the shooting terminal to a target angle by rotating the pan-tilt to the target angle.

A product of the target angle and the target times is 360 degrees. It is not difficult to understand that rotating the pan-tilt platform for the target times means rotating the shooting terminal to 360 degrees.

It can be seen therefrom that at the same position, the house images of can be respectively shot by rotating the shooting terminal to 360 degrees at a plurality of angles thereto. Thereby, a house image can be shot from a plurality of shooting angles at the same position in the house room.

In some embodiments, execution subject of the device control method may send a shooting start instruction to the shooting terminal in following manner.

In a first step, creating a shooting item.

In some scenarios, the shooting items may be created according to item names entered by the user.

In a second step, in response to the shooting item being created successfully, sending the shooting start instruction to the shooting terminal.

It can be seen therefrom that for different houses, the shooting items can be created respectively to shoot house images. Thereby, the house images of a plurality of houses can be managed in an organized manner.

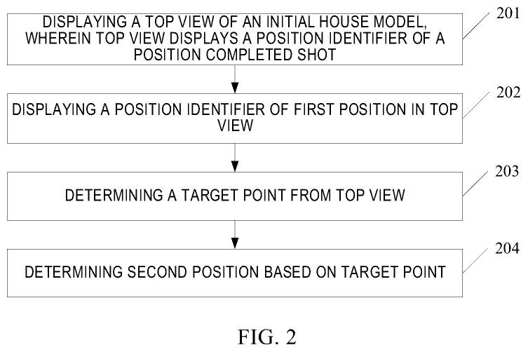

In some embodiments, execution subject may determine a second position according to the procedure shown in FIG. 2. The procedure includes following steps.

Step 201, displaying a top view of an initial house model.

The house model may be a three-dimensional model capable of exhibiting house indoor structure, where the house model may include the initial house model and a target house model.

Above-mentioned top view displays a position identifier of a position completed shot. Therefore, by means of the above-mentioned top view, it is possible to check which positions in house room have been completed shooting.

Step 202: displaying a position identifier of a first position in the top view.

If the user confirms to shoot a house image at a next position, a position identifier of the first position can be displayed in the above-described top view. At this time, from the above-described top view, it can be seen that the first position has been completed shooting.

Step 203: determining a target point from the top view.

Step 204: determining a second position based on the target point.

In practice, points in the above-described top view are in one-to-one correspondence with positions in house room. Therefore, a second position in the house room can be determined according to target point in the above-described top view.

It can be seen therefrom that by means of the top view of the initial house model, the second position for shooting a next house image can be determined.

In some embodiments, execution subject may determine target point from the above-described top view in following manner.

In a first step, determining a target area with sparse position identifier from the above-described top view.

Specifically, coordinates of each position identifier displayed in the above-described top view may be determined, and furthermore, a target area with sparse position identifier may be determined from the above-described top view.

In a second step, determining the target point from the target area.

It can be seen therefrom that the target point can be determined from the target area with sparse position identifier in the above-described top view in conjunction with distribution condition of the position identifier in the above-described top view. Thereby, according to the target point, the second position for shooting the next house image is determined, and distribution uniformity of the position for shooting the house image in the house can be improved. Thus, quality of a house image shot from a plurality of positions in the house room can be improved.

In some embodiments, a display interface of the above-described top view includes a draggable preset identifier. Execution subject may determine the target point from the top view in following manner.

In a first step, based on a user's drag operation on the pre-set identifier, dragging the pre-set identifier into the above-described top view.

In a second step, determining the target point that the pre-set identifier is dragged to in the above-described top view.

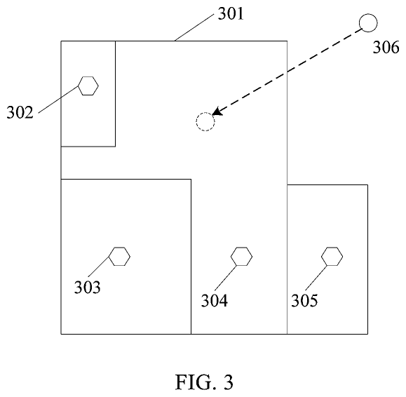

As an example, referring to FIG. 3, a top view 301 and a draggable preset-identifier 306 are shown in presentation interface, wherein the position identifiers 302 to 305 are displayed in the top view 301. A user may drag the preset identifier 306 to a target point in the top view 301.

It can be seen therefrom that, by viewing the above-described top view, the user can know distribution situation of the position identifier in the above-described top view, and further know which positions in house room have been completed shooting. Based on this, the user may drag a pre-set identifier to determine a target point from the above-described top view. Thereby, flexibility of determining a position for shooting a next house image from the house room may be improved.

In some embodiments, before sending a shooting start instruction to a shooting terminal, execution subject may further execute following steps.

In a first step, obtaining local area network information of a local area network connected to a mobile terminal.

In a second step, broadcasting the local area network information, so that the shooting terminal is connected to the above-described local area network.

In response to receiving the local area network information broadcasted by the mobile terminal, the shooting terminal may connect to the local area network according to the local area network information.

It can be seen therefrom that the shooting terminal is connected to the local area network connected to the mobile terminal, which can ensure security of data interaction between the shooting terminal and the mobile terminal.

In some scenarios, after connecting to the local area network, the mobile terminal may serve as a client, and the shooting terminal may serve as a server to perform data interaction.

In some embodiments, execution subject may also perform following steps.

Specifically, for each position where a house image is shot in the house room, in response to completing receiving a plurality of house images shot at the position sent by the shooting terminal, sending a reception completion notification to the shooting terminal, so that the shooting terminal deletes the plurality of house images shot at the position.

For each of above-described positions, after the shooting terminal shoots a plurality of house images at the position, the plurality of images shot at the position may be cached.

It is not difficult to understand that the shooting terminal deletes cached house image, and can release storage space thereon.

In some embodiments, above-described device control method further includes: for each position where a house image is shot in the house room, if the user confirms to re-shoot the house image at the position, sending a re-shooting instruction to the shooting terminal, so that the shooting terminal re-shoots a plurality of house images at the position.

The shooting terminal may send re-shot multiple house images to the mobile terminal.

It can be seen therefrom that by controlling the shooting terminal to re-shoot the house image, quality of the house image shot at each position can be ensured.

In some embodiments, execution subject may also perform at least one of following steps.

In a first step, generating a house panorama based on a plurality of generated target panorama.

It is not difficult to understand that for each position where the house image is shot in the house room, a target panorama can be generated according to a plurality of house images shot at the position. Thereby, the plurality of target panorama may be generated.

The house images generated according to the plurality of target panoramas can display all the scenes in the house room.

In a second step, a target house model is generated according to the plurality of generated target panorama and the initial house model.

In practice, the initial house model may only exhibit house indoor structure and may not exhibit house indoor layout.

The target house model generated according to the plurality of target panorama and the initial house model can exhibit house indoor layout.

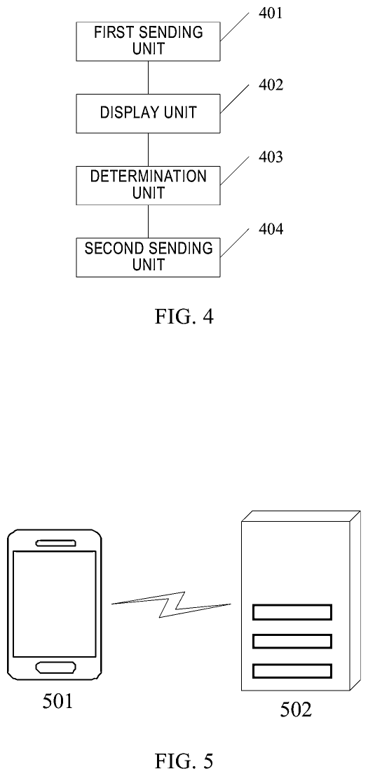

Further referring to FIG. 4, as an implementation of the method shown in the above-described drawings, the present disclosure provides one embodiment of a device control apparatus. The embodiment of the apparatus corresponds to method embodiment shown in FIG. 1, and the apparatus may be specifically applied to various electronic devices.

As shown in FIG. 4, the device control apparatus according to this embodiment includes a first sending unit 401, a display unit 402, a determination unit 403, and a second sending unit 404. The first sending unit 401, for sending a shooting start instruction to a shooting terminal, so that the shooting terminal shoots a plurality of house images at a first position in a house room; the display unit 402 for, in response to receiving the plurality of house images sent by the shooting terminal, generating a target panorama based on the plurality of house images, and displaying the target panorama, so that a user confirms to shoot a house image at a next position, or to re-shoot a house image at a first position; the determination unit 403 for, if the user confirms to shoot the house image at the next position, determining a second position in the house room; the second sending unit 404 for, sending the second position information to the shooting terminal, so that the shooting terminal shoots a plurality of house images at the second position.

In this embodiment, for specific processing of the first sending unit 401, the display unit 402, the determination unit 403, and the second sending unit 404 of the device control apparatus and a technical effect brought about by the processing, reference may be made to related descriptions of step 101, step 102, step 103, and step 104 in corresponding embodiments of FIG. 1, and details are not repeatedly described herein.

In some embodiments, the determination unit 403 is further used for displaying a top view of an initial house model, wherein displaying a position identifier of a position has been completed shooting in above-described top view, and displaying a position identifier of a first position in the above-described top view; determining a target point from the above-described top view; determining a second position according to the target point.

In some embodiments, the determining unit 403 is further used for determining a target area with sparse position identifier from the above-described top view; determining a target point from the above-described target area.

In some embodiments, display interface of the above-described top view includes a draggable pre-set identifier; the determination unit 403 is further used for, based on a drag operation performed by the user on the pre-set identifier, dragging the pre-set identifier into the above-described top view; determining the target point that the pre-set identifier is dragged to in the above-described top view.

In some embodiments, the shooting terminal is provided with a rotatable pan-tilt; a camera terminal shoots a plurality of house images at the same position in a house room by executing a shooting step for a target times, wherein the shooting step includes: shooting at least one house image; after shooting is completed, rotating the shooting terminal to target angle by rotating the pan-tilt target angle, wherein a product of the target angle and the target times is 360 degrees.

In some embodiments, the device control apparatus further includes a broadcasting unit (not shown in drawings), wherein the broadcasting unit is used for obtaining local area network information of a local area network connected to the mobile terminal; broadcasting the local area network information, so that the shooting terminal is connected to the local area network.

In some embodiments, the apparatus control apparatus further includes a third sending unit (not shown in drawings), wherein the third sending unit is used for, for each position where a house image is shot in the house room, in response to completing receiving a plurality of house images shot at the position sent by the shooting terminal, sending a reception completion notification to the shooting terminal, so that the shooting terminal deletes the plurality of house images shot at the position.

In some embodiments, the first sending unit 401 is further used for creating a shooting item, and in response to that the shooting item being created successfully, sending the shooting start instruction to the shooting terminal.

In some embodiments, the apparatus control apparatus further includes a fourth sending unit (not shown in the drawing), wherein the fourth sending unit is used for, for each position where a house image is shot in the house room, if the user confirms to re-shoot the house image at the position, sending a re-shooting instruction to the shooting terminal, so that the shooting terminal re-shoots a plurality of house images at the position.

In some embodiments, the device control apparatus further includes a generation unit (not shown in the drawing), wherein the generation unit is used for generating a house panorama based on a plurality of generated target panorama; and/or, generating a target house model based on the plurality of generated target panorama and an initial house model.

With further reference to FIG. 5, FIG. 5 illustrates an exemplary system architecture in which the device control method of the present disclosure may be applied in one embodiment.

As shown in FIG. 5, the system architecture may include a mobile terminal 501 and a shooting terminal 502. The mobile terminal 501 and the shooting terminal 502 may implement interaction in a plurality of manners such as a wireless local area network and Bluetooth.

An application for controlling the shooting terminal 502 to shoot a house image may be installed on the mobile terminal 501. In some scenarios, the mobile terminal 501 may send a shooting start instruction to the shooting terminal 502, so that the shooting terminal 502 shoots a plurality of house images at a first position in the house. In response to receiving the plurality of house images sent by the shooting terminal 502 are received, the mobile terminal 501 may generate a target panorama based on the plurality of house images, and display the target panorama. If a user confirms to shoot the house image at a next position, the mobile terminal 501 may determine a second position in the house, and send the second position information to the shooting terminal 502, so that the shooting terminal 502 shoots a plurality of house images at the second position

The mobile terminal 501 may be hardware or software. When the mobile terminal 501 is hardware, the mobile terminal 501 may be an electronic device such as a smartphone, a tablet computer, or a laptop computer. When the mobile terminal 501 is a software, the mobile terminal 501 may be installed in the above-described listed electronic devices, may be implemented as a plurality of software or software modules, and may also be implemented as a single software or software module, which is not limited herein.

The shooting terminal 502 may be hardware or software. When the shooting terminal 502 is hardware, the shooting terminal 502 may be an electronic device for shooting a house image. When the shooting terminal 502 is software, the shooting terminal 502 may be installed in the above-described electronic device, may be implemented as a plurality of software or software modules, and may also be implemented as a single software or software module, which is not limited herein.

The device control method provided by the embodiment of the present disclosure may be executed by the mobile terminal 501. Correspondingly, the device control apparatus may be disposed in the mobile terminal 501.

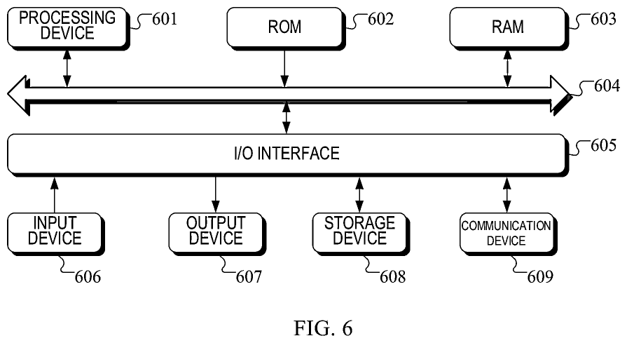

Refer to FIG. 6, which illustrates a schematic structural diagram of an electronic device (e.g., the mobile terminal in FIG. 5) according to embodiments of the present disclosure. The mobile terminal in one embodiment of the present disclosure may include, but is not limited to, such as a mobile phone, a laptop computer, a digital broadcast receiver, a PDA (Personal Digital Assistant), a PAD (tablet computer), a PMP (Portable Multimedia Player), an in-vehicle terminal (e.g., an in-vehicle navigation terminal), and the like. The electronic device shown in FIG. 6 is merely an example and should not bring any limitation to the functions and scope of use of embodiments of the present disclosure. The electronic device shown in FIG. 6 is merely an example and should not bring any limitation to the functions and scope of use of embodiments of the present disclosure.

As shown in FIG. 6, the electronic device may include a processing device (e.g., central processing unit, graphics processor, etc.) 601 that may perform various suitable actions and processes in accordance with a program stored in a read only memory (ROM) 602 or a program loaded into a random access memory (RAM) 603 from a storage device 608. In the RAM 603, various programs and data necessary for the operation of the electronic device are also stored. The processing device 601, the ROM 602, and the RAM 603 are connected to each other via a bus 604. An input/output (I/O) interface 605 is also connected to the bus 604.

In general, the following devices may be connected to the I/O interface 605: input devices 606 including, for example, touch screens, touch pads, keyboards, mice, cameras, microphones, accelerometers, gyroscopes, etc.; an output device 607 including, for example, a liquid crystal display (LCD), a speaker, a vibrator, and the like; a storage device 608 including, for example, a magnetic tape, a hard disk, and the like; and a communication device 609. The communication device 609 can allow the electronic device to communicate wirelessly or wired with other devices to exchange data. While FIG. 6 illustrates an electronic device with a variety of means, it is to be understood that not all of the illustrated means are required to be implemented or provided, and that more or fewer means may alternatively be implemented or provided.

In particular, the processes described above with reference to the flowcharts can be implemented as computer software programs in accordance with embodiments of the present disclosure. For example, embodiments of the disclosure include a computer program product comprising a computer program carried on a non-transitory computer-readable medium, the computer program comprising program code for performing the method as shown in the flowchart. In such one embodiment, the computer program may be downloaded and installed from the network via the communication device 609, or installed from the storage 608, or installed from the ROM 602. When the computer program is executed by the processing device 601, the described functions defined in the method according to the embodiment of the present disclosure are executed.

It should be noted that, the computer readable medium in the embodiments of the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the above-described. More specific examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the above-described. In embodiments of the present disclosure, the computer readable storage medium may be any tangible medium that can contain or store a program for use by or in connection with an instruction execution system, apparatus, or device. However, in embodiments of the present disclosure, a computer readable signal medium may include a propagated data signal in a baseband or as part of a carrier wave, which carries computer readable program codes. Such a propagated signal may take any of a variety of forms, including, but not limited to, electromagnetic, optical, or any suitable combination thereof. A computer readable signal medium may also be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including, but not limited to, wireline, optical fiber cable, RF (radio frequency), etc., or any suitable combination of the above-described.

In some embodiments, clients, servers can communicate using any currently known or future developed network protocol such as HTTP (Hypertext Transfer Protocol) and can be interconnected with digital data communication (e.g., a communication network) in any form or medium. Examples of communication networks include a local area network (“LAN”), a wide area network (“WAN”), an internetwork (e.g., the Internet), and a peer-to-peer network (e.g., an ad hoc peer-to-peer network), as well as any currently known or future developed network.

The computer readable medium may be included in the electronic device, or may exist separately and not be installed in the electronic device. The computer readable medium bears one or more programs. When the one or more programs are executed by the electronic device, the electronic device is enabled to send a shooting start instruction to a shooting terminal, so that the shooting terminal shoots a plurality of house images at a first position in a house room; if the plurality of house images sent by the shooting terminal are received, generating a target panorama according to the plurality of house images, and displaying the target panorama, so that a user confirms that the house images are shot at a next position, or the house images are shot at a first position again; if the user confirms to shoot a house image at the next position, determining a second position in the house; and sending the second position information to the shooting terminal, so that the shooting terminal shoots a plurality of house images at the second position.

Computer program code for carrying out operations for aspects of the present disclosure may be written in any combination of one or more programming languages, including, but not limited to, an object oriented programming language such as Java, Smalltalk, C++ or the like and conventional procedural programming languages, such as the ‘C’ programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the drawings illustrate architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented in a software manner, and may also be implemented in a hardware manner. The names of these units do not constitute a limitation to the units themselves in some cases. For example, the determining unit may also be described as a unit′ if the user confirms to take a house image at the next position, determine the second position in the house′.

The functions described herein above may be performed, at least in part, by one or more hardware logic components. For example, without limitation, exemplary types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In context of the present disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above-described. More specific examples of machine-readable storage media would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the above-described.

The above-described description is merely illustrative of the preferred embodiments of the present disclosure and of the technical principles applied thereto, as will be appreciated by those skilled in the art, The disclosure scope involved in the embodiments of the present disclosure is not limited to the technical solution formed by the specific combination of the described technical features, At the same time, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A device control method, applied to a mobile terminal, comprising:
sending a shooting start instruction to a shooting terminal, so that the shooting terminal shoots a plurality of house images at a first position in a house room;
in response to receiving the plurality of house images sent by the shooting terminal, generating a target panorama based on the plurality of house images, and displaying the target panorama, so that a user confirms to shoot a house image at a next position, or to re-shoot a house image at the first position;
in response to the user confirming to shoot the house image at the next position, determining a second position in the house room; and
sending second position information to the shooting terminal, so that the shooting terminal shoots a plurality of house images at the second position.

2. The method of claim 1, wherein the determining a second position in the house room comprises:
displaying a top view of an initial house model, wherein the top view displays a position identifier of a position completed shot;
displaying a position identifier of the first position in the top view;
determining a target point from the top view; and
determining the second position based on the target point.

3. The method of claim 2, wherein the determining a target point from the top view comprises:
determining a target area with sparse position identifiers from the top view; and
determining the target point from the target area.

4. The method of claim 2, wherein a display interface of the top view comprises a draggable pre-set identifier; and
wherein the determining a target point from the top view comprises:
based on a drag operation performed by the user on the pre-set identifier, dragging the pre-set identifier into the top view; and
determining the target point that the pre-set identifier is dragged to in the top view.

5. The method of claim 1, wherein,
the shooting terminal is provided with a rotatable pan-tilt;
the shooting terminal captures a plurality of house images at the same position in the house room by:
executing a shooting step for a target times, wherein the shooting step comprises:
shooting at least one house image; after shooting is completed, rotating the shooting terminal to a target angle by rotating the pan-tilt to the target angle, wherein a product of the target angle and the target times is 360 degrees.

6. The method of claim 1, wherein before the sending a shooting start instruction to a shooting terminal, the method further comprising:
obtaining local area network information of a local area network connected to the mobile terminal; and
broadcasting the local area network information, so that the shooting terminal is connected to the local area network.

7. The method of claim 1, further comprising:
for each position where a house image is shot in the house room, in response to completing receiving a plurality of house images shot at the position sent by the shooting terminal, sending a reception completion notification to the shooting terminal, so that the shooting terminal deletes the plurality of house images shot at the position.

8. The method of claim 1, wherein the sending a shooting start instruction to a shooting terminal comprises:
creating a shooting item; and
in response to the shooting item being created successfully, sending the shooting start instruction to the shooting terminal.

9. The method of claim 1, further comprising:
for each position where a house image is shot in the house room, in response to the user confirming to re-shoot the house image at the position, sending a re-shooting instruction to the shooting terminal, so that the shooting terminal re-shoots a plurality of house images at the position.

10. The method of claim 1, further comprising:
generating a house panorama based on a plurality of generated target panorama; and/or
generating a target house model based on the plurality of generated target panorama and an initial house model.

11. (canceled)

12. An electronic device, comprising:
one or more processors;
a storage apparatus for storing one or more programs;
when the one or more programs are executed by the one or more processors, causing the one or more processors to implement a device control method, the device control method comprising:
sending a shooting start instruction to a shooting terminal, so that the shooting terminal shoots a plurality of house images at a first position in a house room;
in response to receiving the plurality of house images sent by the shooting terminal, generating a target panorama based on the plurality of house images, and displaying the target panorama, so that a user confirms to shoot a house image at a next position, or to re-shoot a house image at the first position;
in response to the user confirming to shoot the house image at the next position, determining a second position in the house room; and
sending second position information to the shooting terminal, so that the shooting terminal shoots a plurality of house images at the second position.

13. A non-transitory computer readable medium, on which a computer program is stored, wherein the computer program when being executed by a processor, implements
a device control method comprising:
sending a shooting start instruction to a shooting terminal, so that the shooting terminal shoots a plurality of house images at a first position in a house room;
in response to receiving the plurality of house images sent by the shooting terminal, generating a target panorama based on the plurality of house images, and displaying the target panorama, so that a user confirms to shoot a house image at a next position, or to re-shoot a house image at the first position;
in response to the user confirming to shoot the house image at the next position, determining a second position in the house room; and
sending second position information to the shooting terminal, so that the shooting terminal shoots a plurality of house images at the second position.

14. The electronic device of claim 12, wherein the determining a second position in the house room comprises:
displaying a top view of an initial house model, wherein the top view displays a position identifier of a position completed shot;
displaying a position identifier of the first position in the top view;
determining a target point from the top view; and
determining the second position based on the target point.

15. The electronic device of claim 14, wherein the determining a target point from the top view comprises:
determining a target area with sparse position identifiers from the top view; and
determining the target point from the target area.

16. The electronic device of claim 14, wherein a display interface of the top view comprises a draggable pre-set identifier, and
wherein the determining a target point from the top view comprises
based on a drag operation performed by the user on the pre-set identifier, dragging the pre-set identifier into the top view; and
determining the target point that the pre-set identifier is dragged to in the top view.

17. The electronic device of claim 12, wherein,
the shooting terminal is provided with a rotatable pan-tilt;
the shooting terminal captures a plurality of house images at the same position in the house room by:
executing a shooting step for a target times, wherein the shooting step comprises: shooting at least one house image; after shooting is completed, rotating the shooting terminal to a target angle by rotating the pan-tilt to the target angle, wherein a product of the target angle and the target times is 360 degrees.

18. The electronic device of claim 12, wherein before the sending a shooting start instruction to a shooting terminal, the method further comprises:
obtaining local area network information of a local area network connected to the electronic device; and
broadcasting the local area network information, so that the shooting terminal is connected to the local area network.

19. The electronic device of claim 12, wherein the method further comprises:
for each position where a house image is shot in the house room, in response to completing receiving a plurality of house images shot at the position sent by the shooting terminal, sending a reception completion notification to the shooting terminal, so that the shooting terminal deletes the plurality of house images shot at the position.

20. The electronic device of claim 12, wherein the sending a shooting start instruction to a shooting terminal comprises:
creating a shooting item; and
in response to the shooting item being created successfully, sending the shooting start instruction to the shooting terminal.

21. The electronic device of claim 12, wherein the method further comprises:
for each position where a house image is shot in the house room, in response to the user confirming to re-shoot the house image at the position, sending a re-shooting instruction to the shooting terminal, so that the shooting terminal re-shoots a plurality of house images at the position.
